(19) United States
(12) Patent Application Publication
(10) Pub. No.: US 2011/0184758 A1
(43) Pub. Date: Jul. 28, 2011

(54) Electronic medication aministration record system for low patient trust environments

(76) Inventors: Johnny White, Frisco, TX (US); Andrew Morgan, Wylie, TX (US); Cherie Shew, Aubrey, TX (US)

(21) Appl. No.: 12/931,102

(22) Filed: Jan. 24, 2011

Related U.S. Application Data
(60) Provisional application No. 61/336,456, filed on Jan. 22, 2010.

(51) Int. Cl. G06Q 50/00

(52) U.S. Cl. 705/3

(57) ABSTRACT

A system for electronic medication administration records system utilizing a computer processing unit and an operating system in a correctional facility. The system updates patient history and medication distribution to certain patient inmates recording the distribution and inmate signature for accurate and irrefutable records. The system creates auto mapping medical distribution, but can be updated manually for unrecognizable drug administration for inmates. The system sends updates for medical history of inmates and notifies administrator for prescription refills and/or medication reorders. The system works in conjunction with a health care server.

### CLAIM OF PRIORITY

This application claims priority to U.S. Provisional Patent Application No. 61/336,456 to common inventors White, et al., dated 22 Jan. 2010 and entitled Electronic Medication Administration Record (eMar) System.

### FIELD OF THE INVENTION

The present invention relates to electronic medicine record systems.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

The present invention relates to electronic medicine record systems for low-trust patient environments, such as correctional facilities. Correctional medical environments are different from most medical settings in that in addition to prescribing medications; they also administer the medications to patients, and the patients may have economic or other incentives to be non-compliant with the administration of their prescribed medications. Presently, this administration is done exclusively with paper forms that must be updated several times a day. This process is very time consuming and prone to error. Although several electronic MARs currently exist; however, none address the needs of a low-trust patient environment, such as that at a correctional institution.

Presently, for dispensing medications to patients, a correctional facility orders the medications. Then, an employee, commonly a nurse, pulls the medication and dispenses it to inmates. Often the case, inmates may receive several medications at several different times throughout each day. Correctional facilities have to keep track of each medication, when it was dispensed, to which inmate, how much of the medication, and verify that the medication was actually taken. Keeping track of all of these variables, numbers, and names is time consuming and often error prone for these large scale facilities. In addition, the individuals, the inmates, who receive these medications, are not reliable and often themselves create extra confusion for the facility and its employees. For example, inmates may try to trick the dispensing nurse into giving them extra pills, or trick the nurse into believing that they have taken pill(s) that have been dispensed, all the while intending to spit out the pills, let them dry, and sell the pills (for great value) on the prison black market. Therefore, these correctional facilities need an electronic medical record system that is efficient, reliable, and meets the special needs of a low-trust patient environment.

### BRIEF DESCRIPTION OF THE DRAWINGS

Various aspects of the invention, as well as an embodiment, are better understood by reference to the following detailed description. The detailed description, given by way of examples and not intended to limit the present invention solely thereto, will be better understood when read in conjunction with the drawings wherein like reference numerals denote like elements and parts in which:

FIG. 1 is a view of the inventive medical information system.

FIG. 2 is an inventive medication dispensing algorithm.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise. As will be understood by those of ordinary skill in the art, various structures and devices are depicted in block diagram form in order to avoid unnecessarily obscuring the invention.

It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise.

Some methods of the invention may be practiced by placing the invention on a computer-readable medium, particularly the control and detection/feedback methodologies. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to operate the methods of the invention. It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise.

### DETAILED DESCRIPTION OF THE DRAWINGS

The present invention is a system and a method that enables correctional facilities to provide superior care to inmates by providing accurate information about those inmates, including what medications need to be administered and what PRNs (the medical field's abbreviation for a prescription, based on the Latin) are available. The system has protection for accuracy by recording specific individual inmate information when inmate receives medication, such as a signature. The signature recorder verifies that the specific medication has in fact been distributed to the specific inmate even if the inmate claims otherwise. The extra record creates additional certainty.

Correctional medical environments are different from most medical settings in that in addition to prescribing medications, they also administer the medications to patients. Presently, many administrations exclusively use paper forms that must be updated several times each day. This process is very time consuming and prone to error. Sometimes an inmate may claim that he has not received specific medication which he was supposed to be given—or even try to resist taking the medication, perhaps as a show of defiance. Under the system of manually records, only paper copy could prove that the inmate was correct or incorrect in his claim, and if the paper copy is lost or altered, the inmate could suffer harm and the penitentiary could be subject to legal action. The inmates'accusations create needless confusion and time-consuming strain on the facility staff that creates additional costs for the facility as well. This Electronic Medication Administration System (eMAR) addresses the issues that face the correctional environment.

Prior to the MAR process for a patient to begin, the provider must order the medication. The medication order is placed with a system module that contains several descriptions for the medication such as: medication name (Tylenol), medication strength (dose), medication form (tablet), medication route (oral), directions, SIG (take one tablet three times a day for seven days), start date, stop date, quantity, brand, prescribed elsewhere, and sample. This is a lot of information to address manually with every single administered dose. This information is therefore entered into the system electronically as the nurse is prompted for that data entry. This eMAR works in conjunction with a healthcare server such as NextGen®. The healthcare server has a database with all of that specific medication information, so when a prescription is filled, the information is transferred from the healthcare server into the eMAR system.

Depending on the practices of the pharmacy being used, the pharmacy may provide a paper MAR of all the medications that they provide. If more than one pharmacy is used, the various MARs must be consolidated or cross referenced by the nurse to insure the patients receive all the medications prescribed for them. The MARs can be entered automatically, but the system allows for manually created MARs in case electronic MARs were not available from the pharmacy or healthcare server.

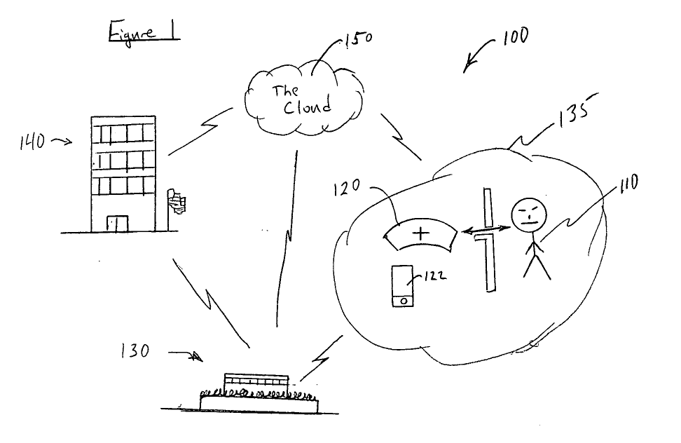

FIG. 1 is a block-diagram of the inventive medical administration system 100 for performing the inventive process. The system 100 includes an inmate 110 whose information is shared with a healthcare provider 140. The health care provider 140 provides prescriptions, and other medical-related needs such as syringes, etc, which can be shipped by the provider itself or an unrelated pharmacy. Generally prisons work in conjunction with a particular pharmacy.

The medications and medical items are received by the prison's administration 130, where the mapping process is designed and/or received via the eMAR program. The administration 130 then distributes the drugs according to the mapping instructions to specific nursing stations 120 having local input/output computing devices 122, such as tablet computing devices an example of which is the iPad®, which includes a scanner such as a camera. The administration 130 generally distributes to many stations in one facility, but may also be a centralized system and work across a plurality of prison facilities. Accordingly, in one embodiment the bubble 135 represents a nursing station and patient in a single prison facility, while in another embodiment the bubble 135 may represent a nursing station and patient located in a facility separate from that facility that houses the administration 130. The nursing station 120 delivers the medication to the prisoner 110. In practice, the inmate 110 shows the nurse that he has ingested the medication and the nurse reports that information to the eMAR system which reports it to the administrator. When the medication levels are low, the administrator submits to the healthcare provider the need for more medication.

Communication across the system 100 is achieve electronically, and is illustrated as “bolts” in FIG. 1. Of note, the system includes communication with The Cloud, on which the inventive eMAR may reside, store data, or otherwise communicate with via cloud computing systems such as those that incorporate Microsoft's® Azure® database.

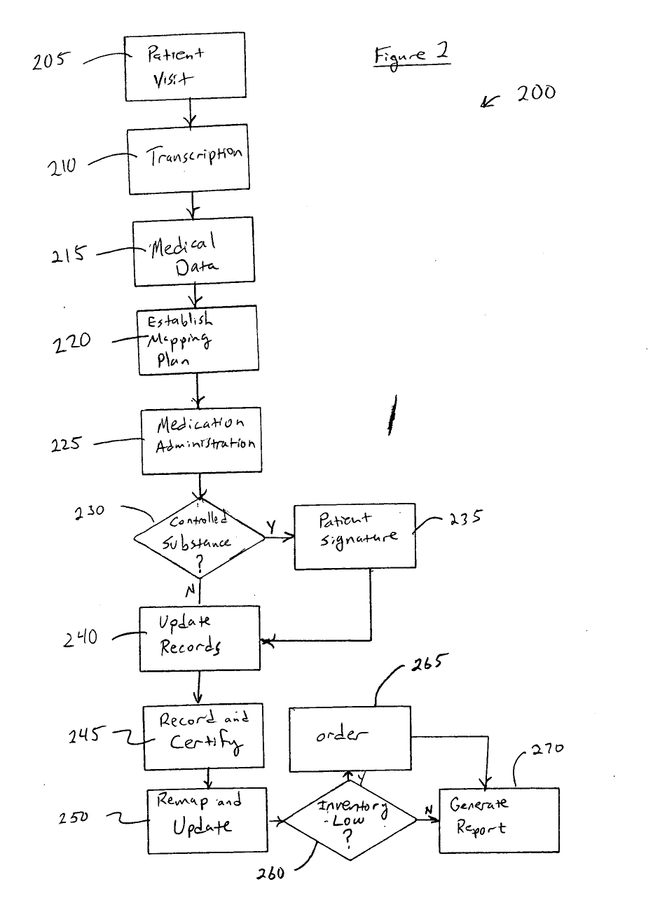

FIG. 2 is an inventive medication dispensing algorithm 200. The algorithm 200 starts when a correctional inmate visits a doctor and a report is generated with medication instructions, a prescription, in a patient visit act 205. The prescription is next transcribed into the medication administration record system in a transcription act 210. The information transcribed may include: medical unit site name, patient location, patient inmate identification, patient name, patient birth date and age, patient allergies, the medication name and strength, the SIG, start date, stop date, ordering provider name, date and time administered and space for administer (a nurse) name or initials, comment section, and space for patient signature. In the next act, the medical data act 215, the medical data and inmate information is entered into the eMAR. The first time the data is entered typically takes the most time, but the majority of the information for each inmate only needs to be entered the first time, after that, only changes in medical history, medications, or inmate conditions need to be entered in future system accesses to run the algorithm 200.

Next the algorithm establishes a mapping plan in an establish mapping plan act 220. This plan is for certain medications to go to floors for certain inmates at certain times in order to establish the most efficient form of distribution while fulfilling all of the inmates' medication requirements. Then, as medications are administered, the nurse records the date and time of administration and initials the entry in a medication administration act 225. In the case of a controlled substance medications and others specified by correctional facility policy, the nurse must also obtain the patients signature indicating that they received the medication indicated by a controlled substance query 230 and a patient signature act 235 reached through the yes “Y” decision path. The signature can be electronically recorded and can be a fingerprint signature which further reduces error. The required patient signature is for site protection providing actual evidence that the patient did in fact receive the medication in case the patient claims otherwise.

Some medications, such as controlled medications, must be tracked separately from other medications. In a manual system, this typically means separate MARs are created and kept in separate files, log books or clip boards. In an electronic system, a means should be provided to view these medications in a separate screen and/or to mark them as requiring special handling according to practice policy.

On a regular basis, the nurse is required to create updated medical administration records in an optional update records act 240, whereby all active medications should be transferred to the new medical administration record, new medications added, and recently discounted medications added and marked as discontinued. They algorithm 200 records the medications distributed to certify accurate distribution numbers and prevent theft or unauthorized medication distribution in a record and certify act 245. This is yet another level of security for displaying whether a certain medication has or has not been distributed properly.

Then, once the medication is distributed and the distribution is recorded into the eMAR, the eMAR will remap the amounts of medications and update the inmate plans in order to create the next map for the nurse for the next round of medication distribution—this happens in a remap and update act 250. When the medication amounts run out or get low according to the system, the system creates an order, as shown in an inventory low query 255 and an optional order act 260.

Next, the algorithm 200 creates a report on which medications need to be ordered and which medications are low from the collection of eMARs for the entire correctional facility in a generate report act 270, and ends. Medications are generally received from the pharmacy in quantities to cover 30 days. When the order is for more than 30 days, the pharmacy typically provides a sheet of peel off labels, identified by patient and prescription, which the nurse can use to easily reorder the medication for the next 30 days. The nurse typically files these sheets and reviews them on a regular basis to insure the new supply is received in time for continuity of administration. eMAR automates this practice as well in a separate algorithm. The full inventory management component and report prompts the nurse when a reorder or a refill is required.

The application preferably utilizes an active user interface whereby data lists can be sorted and reordered by the user and the data in the columns can be sorted from ascending or descending number data or alphabetically if numbers do not apply. In one embodiment, this is accomplished in a drag-and-drop manner. The system creates the plan and notifies the nurse of activity for each individual inmate to maintain accurate eMAR for each inmate.

Though the invention has been described with respect to a specific preferred embodiment, many advantages, variations and modifications will become apparent to those skilled in the art upon reading the present application. In particular, although inmates are specifically identified as patients herein, other low trust patients include the mentally ill, the mentally incapacitated, the severely physically incapacitated, and the elderly. It is therefore the intention that the appended claims and their equivalents be interpreted as broadly as possible in view of the prior art to include all such variations and modifications.

We claim:

1. A system for electronic medication administration records comprising:
at a nursing station in a correctional facility with inmate patients, a computing device having an operating system;
a scanner in communication with the operating system;
an electronic administration page integrated with the operating system;
a healthcare provider with access to a health care provider database;
wherein the system utilizes a plan builder algorithm to automatically map medication SIG codes according to a plan;
wherein the plan is updated by a nurse;
wherein the administration page allows an administrator to update the plan for each inmate; and
the plan sends alerts to the administration when a medication for an inmate needs to be refilled by reorder.

2. The system of claim 1 wherein the nursing station comprises a user display.

3. The system of claim 2 wherein the eMAR locks the medications until the proper time, when they arrive at their proper location which is electronically detected, and to the proper inmate as electronically identified.

4. The system of claim 1 wherein the user data input device records fingerprint signatures.

5. The system of claim 1 wherein the scanner is scans bar codes of medications, inmate badges, nurse badges, and administrator badges.

6. The system of claim 1 wherein the plan comprises a list of the inmate's medical history, medical information, medication procedures for a given day, and information indicating whether such medications have been received by each inmate;

7. The system of claim 1 wherein the plan is updated by recording an electronic signature for an inmate who received medication.

8. A method of administrating medical records, comprising:
receiving an inmate patient data to create a medical record;
automatically generating a mapping plan;
receiving data indicating compliance with the mapping plan during medication administration to the inmate patient; and
updating the inmate patient medical record.

9. The method of claim 8 further comprising receiving an electronic inmate patient signature when a medication is dispensed to the inmate patient.

10. The method of claim 8 further comprising:
receiving a second inmate patient data to create a second medical record;
receiving data indicating compliance with the mapping plan during medication administration to the second inmate patient; and
updating the second inmate patient medical record.

11. The method of claim 10 further comprising certifying the medical records.

12. The method of claim 11 further comprising generating an updated mapping plan.

13. The method of claim 10 further comprising automatically ordering medical supplies.

14. The method of claim 10 further comprising generating a report.

15. The method of claim 10 wherein the medical records are stored remotely on The Cloud.

16. The method of claim 8 wherein data indicating compliance with the mapping plan includes geolocation data.

17. The method of claim 8 wherein data indicating compliance with the mapping plan includes an inmate patient identification (ID).

18. The method of claim 17 wherein the inmate patient ID is a biometric ID.
